(19) United States
(12) Patent Application Publication
(10) Pub. No.: US 2017/0155137 A1
(43) Pub. Date: Jun. 1, 2017

(54) POSITIVE ACTIVE MATERIAL AND NON-AQUEOUS ELECTROLYTE SECONDARY BATTERY

(71) Applicant: Sony Corporation, Tokyo (JP)

(72) Inventors: Izaya OKAE, Fukushima (JP); Keizo KOGA, Fukushima (JP); Takehiko TANAKA, Fukushima (JP)

(21) Appl. No.: 15/432,370

(22) Filed: Feb. 14, 2017

Related U.S. Application Data
(63) Continuation of application No. 10/646,226, filed on Aug. 22, 2003.

(30) Foreign Application Priority Data
Aug. 27, 2002 (JP) 2002-246848

(51) Int. Cl. H01M 4/36; H01M 4/525; H01M 4/58

(52) U.S. Cl. CPC H01M 4/366; H01M 4/5825; H01M 4/525

(57) ABSTRACT

A positive active material is provided. The positive active material includes particles of lithium nickelate and an olivine compound having an olivine crystal structure, wherein surfaces of the particles of lithium nickelate are covered with the olivine compound. The lithium nickelate is expressed by a general formula Li_{y}Ni_{1-z}M′_{z}O₂ where 0.05≦y≦1.2 and 0≦z≦0.5, and M′ includes Fe, Co, Mn, Cu, Zn, Al, Sn, B, Ga, Cr, V, Ti, Mg, Ca, Sr and mixtures thereof. The olivine compound is expressed by a general formula LiₓMPO₄ where 0.05≦x≦1.2, and M includes Fe, Mn, Co, Ni, Cu, Zn, Mg and mixtures thereof. A non-aqueous electrolyte secondary battery including the positive active material is also provided.

### CROSS-REFERENCE TO RELATED APPLICATIONS

The present application is a continuation of U.S. application Ser. No. 10/646,226, filed Aug. 22, 2003, which claims priority to Japanese Application No. 2002-246848, filed Aug. 27, 2002, the disclosures of which are hereby incorporated by reference herein.

### BACKGROUND OF THE INVENTION

The present invention relates to a positive active material allowing lithium to be reversibly doped or undoped in or from the material, and a non-aqueous electrolyte secondary battery using the positive active material.

Lithium nickelate expressed by a general formula Li_{y}Ni_{1-z}M′_{z}O₂ where 0.05≦y≦1.2 and 0≦z≦0.5, and M′ is one kind or more selected from a group consisting of Fe, Co, Mn, Cu, Zn, Al, Sn, B, Ga, Cr, V, Ti, Mg, Ca, and Sr is known as an active material capable of obtaining a charge/discharge capacity higher than that of lithium cobaltate having been widely used as a positive active material for lithium ion secondary batteries.

While the discharge capacity of lithium cobaltate is about 150 mAh/g, the discharge capacity of lithium nickelate is in a range of about 180 to 200 mAh/g. Since nickel as a raw material of lithium nickelate is lower in cost than cobalt, lithium nickelate is superior to lithium cobaltate in terms of cost. Further, since nickel is superior to cobalt in stability of supply of raw mineral ores, lithium nickelate is superior to lithium cobaltate in terms of stability of supply of raw materials.

Lithium nickelate having such advantages, however, is disadvantageous in that stability in charge state is lower than that of lithium cobaltate. The reason for this is that stability of the crystal structure of lithium nickelate is low due to instability of quadrivalent Ni ions produced upon charging and thereby reactivity with an electrolytic solution is high, and that a thermal-decomposition starting temperature of lithium nickelate is lower than that of lithium cobaltate. As a result, there occurs a problem in increasing degradation of lithium nickelate at the time of charge/discharge cycle at a high temperature or at the time of retention of a high temperature in a charge state.

On the other hand, an olivine compound containing polyaniline as a basic skeleton, which is expressed by a general formula LiₓMPO₄ where 0.05≦x≦1.2, and M is one kind or more selected from a group consisting of Fe, Mn, Co, Ni, Cu, Zn, Mg, Cr, V, Mo, Ti, Al, Nb, B, and Ga is known as a positive material for lithium ion secondary batteries.

In the case of using the olivine compound as a positive active material of a secondary battery, since the change in crystal structure of the olivine compound due to charging/discharging is small, the olivine compound is effective to enhance the cycle characteristic, and since oxygen atoms in crystals are covalently bound to phosphorus atoms in crystals and are thereby stably present in the crystals, the possibility of discharge of oxygen is small even when the battery is exposed to a high temperature environment, which is a merit of enhancing safety.

The olivine compound having the above-described advantages is used in the form of particles, and in this case, the olivine compound has a disadvantage that the energy density is low. The discharge capacity per weight of lithium cobaltate having been generally used for lithium ion secondary batteries is about 150 mAh/g and the discharge capacity per weight of lithium nickelate is in a range of about 180 to 200 mAh/g, whereas the discharge capacity per weight of the olivine compound (even if the olivine compound is of a type having a high charge/discharge ability) is not more than the discharge capacity of lithium cobaltate. Further, the true density of lithium cobaltate is 5.1 g/cm³ and the true density of lithium nickelate is 4.8 g/cm³, whereas the true density of the olivine compound is about 3.5 g/cm³. That is to say, the true density of the olivine compound is lower than each of lithium cobaltate and lithium nickelate by about 30%.

Accordingly, if the olive compound is singly used for a battery, the energy density per volume becomes low, failing to satisfy the consumer's needs toward higher capacity. The olivine compound has another disadvantage that the electron conductivity is low. As a result, if the olivine compound is singly used as a positive active material, there occurs a problem that the load characteristic becomes poorer than that of each of lithium cobaltate and lithium nickelate.

It is conceivable to use the mixture of lithium nickelate and the olivine compound as a positive material for making effective use of the advantages of both the materials; however, a large amount, for example, 50 wt % or more of the olivine compound is required to be mixed with lithium nickelate in order to derive stability in a high temperature service state of the battery using lithium nickelate, thereby failing to obtain a high charge/discharge capacity as the advantage of lithium nickelate.

### SUMMARY OF THE INVENTION

The present invention provides a positive active material having combined advantages of lithium nickelate and an olivine compound, that is, having a high discharge capacity and good high-temperature stability, and to provide a non-aqueous electrolyte secondary battery using the positive active material.

In this regard, it has been found that it is effective to cover surfaces of particles of lithium nickelate with an olivine compound for maximizing characteristics of lithium nickelate and the olivine compound.

According to an embodiment of the present invention, there is provided a positive active material including: particles of lithium nickelate expressed by a general formula Li_{y}Ni_{1-z}M′_{z}O₂ where 0.05≦y≦1.2 and 0≦z≦0.5, and M′ is one kind or more selected from a group consisting of Fe, Co, Mn, Cu, Zn, Al, Sn, B, Ga, Cr, V, Ti, Mg, Ca, and Sr; and an olivine compound having an olivine type crystal structure expressed by a general formula LiₓMPO₄ where 0.05≦x≦1.2, and M is one kind or more selected from a group consisting of Fe, Mn, Co, Ni, Cu, Zn, and Mg; wherein surfaces of the particles of lithium nickelate are covered with the olivine compound.

According to another embodiment of the present invention, there is provided a non-aqueous electrolyte secondary battery including: a positive electrode including a positive active material; a negative electrode containing a material selected from a group consisting of metal lithium, a lithium alloy, and a material allowing lithium to be doped or undoped in or from the material; and a non-aqueous electrolyte. The positive active material includes: particles of lithium nickelate expressed by a general formula Li_{y}Ni_{1-z}M′_{z}O₂ where 0.05≦y≦1.2 and 0≦z≦0.5, and M′ is one kind or more selected from a group consisting of Fe, Co, Mn, Cu, Zn, Al, Sn, B, Ga, Cr, V, Ti, Mg, Ca, and Sr; and an olivine compound having an olivine type crystal structure expressed by a general formula LiₓMPO₄ where 0.05≦x≦1.2, and M is one kind or more selected from a group consisting of Fe, Mn, Co, Ni, Cu, Zn, and Mg; wherein surfaces of the particles of lithium nickelate are covered with the olivine compound.

The positive active material according to an embodiment of the present invention described above can suppress reaction between an electrolyte and lithium nickelate because the surfaces of particles of lithium nickelate are covered with the olivine compound excellent in stability, to enhance stability of lithium nickelate in a high temperature state.

More specifically, the stability of lithium nickelate can be enhanced in a high temperature state while keeping a high charge/discharge capacity of lithium nickelate and suppressing a reduction in energy density by addition of the olivine compound, and hence to combine a charge/discharge capacity and high-temperature stability, for example, a cycle characteristic and a retention characteristic at a high level.

According to an embodiment of the present invention, by covering surfaces of particles of lithium nickelate with the olivine compound, that is, by collectively disposing the olivine compound on the surfaces of particles of lithium nickelate, it is possible to efficiently obtain an effect of suppressing reaction between lithium nickelate and an electrolytic solution with a small amount of the olivine compound. As a result, the amount of the olivine compound can be reduced as compared with the amount of the olivine compound simply mixed with lithium nickelate, with a result that the reduction in energy density due to addition of the olivine compound can be suppressed.

Since the olivine compound adheres on surfaces of particles of lithium nickelate, the low electron conductivity of the olivine compound is compensated by the high electron conductivity of lithium nickelate. As a result, it is possible to sufficiently derive the characteristic of the olivine compound without reducing the energy density as compared with the case using the single olivine compound as a positive active material.

An important aspect of the present invention lies in that the olivine compound is provided not so as to simply adhere on surfaces of particles of lithium nickelate but so as to cover the surfaces of particles of lithium nickelate. If the olivine compound is provided so as to adhere at random on the surfaces of particles of lithium nickelate by simply mixing the olivine compound with the particles of lithium nickelate, the above-described effect cannot be obtained. That is to say, the above-described effect can be obtained by uniformly covering the surfaces of particles of lithium nickelate with the olivine compound according to an embodiment of the present invention.

Since the non-aqueous electrolyte secondary battery of the present invention uses the above-described positive active material, it is possible to combine the charge/discharge capacity with the high-temperature stability at a high level.

Additional features and advantages of the present invention are described in, and will be apparent from, the following Detailed Description of the Invention and the figures.

### BRIEF DESCRIPTION OF THE FIGURES

FIG. 1 is a sectional view showing an example of a coin-shaped non-aqueous electrolyte secondary battery according to an embodiment of the present invention.

FIG. 2 is a schematic view showing a configuration of a disk mill as an example of a high-speed rotary type impact crusher used in Example 1.

FIG. 3 is a schematic view showing a material treated by the disk mill according to an embodiment of the present invention.

FIG. 4 is a sectional view showing an example of a cylindrical non-aqueous electrolyte secondary battery according to an embodiment of the present invention.

FIG. 5 is a characteristic diagram showing a relationship between a discharge capacity and a cycle number for a battery produced in Example 1.

FIG. 6 is a schematic view showing a configuration of a mixer/crusher used in Example 2.

FIG. 7 is a schematic view showing a configuration of a high-speed agitator/mixer used in Example 3.

### DETAILED DESCRIPTION OF THE INVENTION

The present invention generally relates to positive active materials. More specifically, the present invention relates to positive active materials that allow lithium to be reversibly doped or undoped in or from the material, and non-aqueous electrolyte secondary batteries that employ the positive active material. The present invention will now be described in detail with reference to the drawings according to an embodiment of the present invention.

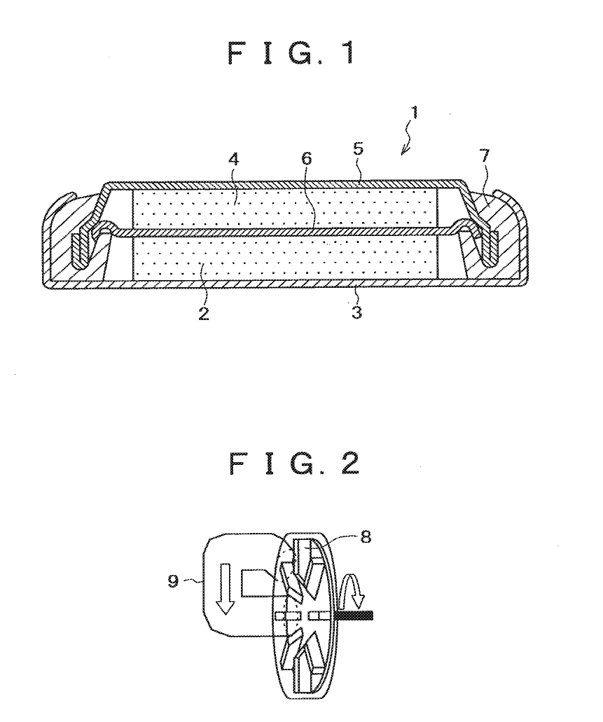

As shown in FIG. 1, a coin-shaped non-aqueous electrolyte secondary battery 1 includes a positive electrode 2, a positive can 3 for containing the positive electrode 2, a negative electrode 4, a negative can 5 for containing the negative electrode 4, a separator 6 disposed between the positive electrode 2 and the negative electrode 4, and an insulating gasket 7. In the case of using an electrolytic solution as an electrolyte, both the positive can 3 and the negative can 5 are filled with a non-aqueous electrolytic solution. In the case of using a solid electrolyte or a gel electrolyte, a solid electrolyte layer or a gel electrolyte layer is formed on active materials of the positive electrode 2 and the negative electrode 4. Each of the positive active material and negative active material is selected as a material allowing lithium to be doped or undoped in or from the material.

The positive electrode 2 is produced by forming a positive active material layer containing the positive active material on a positive current collector. The positive current collector includes an aluminum foil or the like.

The positive active material used herein is prepared by covering surfaces of particles of lithium nickelate with an olivine compound having an olivine type crystal structure. Lithium nickelate is expressed by a general formula Li_{y}Ni_{1-z}M′_{z}O₂ where 0.05≦y≦1.2 and 0≦z≦0.5, and M′ includes one or more constituents that include, for example, Fe, Co, Mn, Cu, Zn, Al, Sn, B, Ga, Cr, V, Ti, Mg, Ca, Sr and the like. The olivine compound is expressed by a general formula LiₓMPO₄ where 0.05≦x≦1.2, and M is one or more constituents that include, for example, Fe, Mn, Co, Ni, Cu, Zn, Mg and the like.

Lithium nickelate expressed by the above general formula Li_{y}Ni_{1-z}M′_{z}O₂ is advantageous in high discharge capacity. Specifically, while the discharge capacity of lithium cobaltate is about 150 mAh/g, the discharge capacity of lithium nickelate is in a range of about 180 to 200 mAh/g. Also, since nickel as a raw material of lithium nickelate is lower in cost than cobalt, lithium nickelate is superior to lithium cobaltate in terms of cost. Further, since nickel is superior to cobalt in stability of supply of raw mineral ores, lithium nickelate is superior to lithium cobaltate in terms of stability of supply of raw materials. Accordingly, the use of lithium nickelate allows preparation of a positive active material having a high discharge capacity at a low cost.

Lithium nickelate having such advantages, however, is disadvantageous in that stability in charge state is lower than that of lithium cobaltate. The reason for this is that stability of the crystal structure of lithium nickelate is low due to instability of quadravalent Ni ions produced upon charging and thereby reactivity with an electrolytic solution is high, and that a thermal-decomposition starting temperature of lithium nickelate is lower than that of lithium cobaltate. As a result, if lithium nickelate is singly used as a positive active material, there occurs a problem in increasing degradation of the positive active material at the time of charge/discharge cycle at a high temperature or at the time of retention of a high temperature in a charge state.

When used as the material of a positive electrode of a secondary battery, the olivine compound having the olivine type crystal structure expressed by the general formula LiₓMPO₄ is advantageous in that since a change in crystal structure accompanied by charge/discharge is small, the olivine compound is excellent in cycle characteristic, and that since oxygen atoms are covalently bound to phosphorus atoms in crystals and are thereby stably present in the crystals, the possibility of discharge of oxygen is small even when the battery is exposed to a high temperature environment.

The use of the olivine compound expressed by the general formula LiₓMPO₄ as a positive active material thus allows production of a non-aqueous electrolyte secondary battery excellent in cycle characteristic and safety.

An olivine compound having an olivine type crystal structure expressed by a general formula LiMPO₄, where M is one kind or more selected from a group consisting of Fe, Mn, Co, Ni, Cu, Zn, Mg, Cr, V, Mo, Ti, Al, Nb, B, and Ga, particularly, LiFePO₄ (hereinafter, generally referred to as “lithium iron phosphate”) is preferably used as a positive active material.

Such a lithium iron phosphate is based on iron that is more abundant in natural resources and more inexpensive than manganese. The use of the lithium iron phosphate as a positive active material thus allows production of a non-aqueous electrolyte secondary battery at low cost, as compared with the use of a lithium-manganese oxide based material as a positive active material.

However, the olivine compound expressed by the general formula LiₓMPO₄ having the above-described advantages is used in the form of particles, and in this case, the olivine compound has a disadvantage that the energy density is low. The discharge capacity per weight of lithium cobaltate generally used for a lithium ion secondary battery is about 150 mAh/g and the discharge capacity per weight of lithium nickelate is in a range of about 180 to 200 mAh/g, whereas the discharge capacity per weight of the olivine compound (even if the olivine compound is of a type having a high charge/discharge ability) is not more than the discharge capacity of lithium cobaltate. Further, the true density of lithium cobaltate is 5.1 g/cm³ and the true density of lithium nickelate is 4.8 g/cm³, whereas the true density of the olivine compound is about 3.5 g/cm³. That is to say, the true density of the olivine compound is lower than each of lithium cobaltate and lithium nickelate by about 30%.

Accordingly, if the olive compound is singly used as a positive active material, the energy density per volume becomes low, failing to satisfy the requirement toward higher capacity. The olivine compound has another disadvantage that the electron conductivity is low. As a result, if the olivine compound is singly used as a positive active material, there occurs a problem that the load characteristic becomes poorer than that of each of lithium cobaltate and lithium nickelate.

To maximize the characteristic of lithium nickelate as a positive active material and the characteristic of the olivine compound as a positive active material, according to an embodiment of the present invention, a positive active material is prepared by covering surfaces of particles of lithium nickelate with the olivine compound. With this configuration, since the surfaces of particles of lithium nickelate are covered with the olivine compound excellent in stability, it is possible to suppress reaction between an electrolytic solution and lithium nickelate and hence to enhance stability of lithium nickelate in a high temperature state. More specifically, it is possible to enhance stability of lithium nickelate at a high temperature state while keeping a high charge/discharge capacity of lithium nickelate and suppressing a reduction in energy density by addition of the olivine compound, and hence to combine a charge/discharge capacity and a high-temperature stability, for example, a cycle characteristic and a retention characteristic at a high level.

An important aspect of the present invention lies in that the olivine compound is provided not so as to simply adhere on surfaces of particles of lithium nickelate but so as to cover the surfaces of particles of lithium nickelate. If the olivine compound is provided so as to adhere at random on the surfaces of particles of lithium nickelate by simply mixing the olivine compound with the particles of lithium nickelate, the above-described effect cannot be obtained. That is to say, the above-described effect can be obtained only by uniformly covering the surfaces of particles of lithium nickelate with the olivine compound.

According to an embodiment of the present invention, by covering surfaces of particles of lithium nickelate with the olivine compound, that is, by collectively disposing the olivine compound on the surfaces of particles of lithium nickelate, it is possible to efficiently obtain an effect of suppressing reaction between lithium nickelate and an electrolytic solution with a small amount of the olivine compound. As a result, the amount of the olivine compound can be reduced as compared with the amount of the olivine compound simply mixed with lithium nickelate, with a result that the reduction in energy density due to addition of the olivine compound can be suppressed.

Since the olivine compound adheres on surfaces of particles of lithium nickelate, the low electron conductivity of the olivine compound is compensated by the high electron conductivity of lithium nickelate. As a result, it is possible to sufficiently derive the characteristic of the olivine compound as compared with the case using the single olivine compound as a positive active material.

The content of the olivine compound on the basis of the total weight of the positive active material is preferably in a range of about 5 wt % to about 50 wt %. If the content of the olivine compound is less than about 5 wt %, the number of particles of the olivine compound covering surfaces of particles of lithium nickelate is too small. As a result, it may fail to sufficiently obtain the effect of the present invention.

If the content of the olivine compound is more than 50 wt %, a high discharge/discharge capacity as an advantage of lithium nickelate cannot be sufficiently obtained, and the superiority in energy density over the conventional active material such as lithium cobaltate is lowered.

Accordingly, by setting the content of the olivine compound within the above-described range, the high-temperature stability can be improved without degrading the high discharge/discharge capacity as the advantage of lithium nickelate so much.

For example, in the case of preparing the positive active material of the present invention by using lithium nickelate having a discharge capacity of about 180 mAh/g and the olivine compound having a discharge capacity of about 150 mAh/g, the discharge capacity of the positive active material becomes a value in a range of about 165 mAh/g to about 178.5 mAh/g. Accordingly, the reduction in discharge capacity of the positive active material can be suppressed to a value of about 8% or less of the discharge capacity of a positive active material made from lithium nickelate only.

In the case of preparing a positive active material by using lithium nickelate having a true density of 4.8 g/cm³ and an olivine compound having a true density of 3.5 g/cm³, the apparent density of the positive active material becomes a value in a range of 4.15 g/cm³ to 4.74 g/cm³. Accordingly, the reduction in density can be suppressed to a value of about 14% or less.

As the olivine compound used for the present invention, there is preferably used an olivine compound synthesized at a baking temperature of about 500° C. to about 700° C. as disclosed in Japanese Patent Laid-open No. 2001-250555. It has been confirmed that an average particle size of the olivine compound synthesized at such a baking temperature is generally smaller than that of lithium nickelate, and more specifically, becomes as small as at least one-half or less of an average particle size of lithium nickelate. For example, while the average particle size of lithium nickelate is in a range of about 10 μm to about 20 μm, the average particle size of the olivine compound is in a range of about 5 μm or less.

The term “average particle size” used herein or other like terms means a value measured in a mixed state of partial primary particles and secondary particles as aggregates of primary particles. Since secondary particles of the olivine compound can be easily pulverized into primary particles as compared with secondary particles of lithium nickelate, particles of the olivine compound synthesized at the above-described baking temperature can be almost pulverized to particles having sizes being about one-tenth of particles of lithium nickelate. In other words, the particle sizes of the olivine compound can be reduced to particle sizes desirable as those of the material for covering surfaces of secondary particles of lithium nickelate. On the contrary, in the case of using an olivine compound obtained by baking at a temperature of more than 700° C., since sizes of primary particles become too large, such an olivine compound is undesirable as the material for covering surfaces of particles of lithium nickelate.

As a result of calculation, it becomes apparent that if the particle size of the olivine compound is one-half or less of the particle size of lithium nickelate, 28 pieces or more of the particles of the olivine compound can be disposed on the surface of one of the particles of lithium nickelate. Such a particle size relationship is important to obtain a desired effect of the present invention.

According to an embodiment of the present invention, the average particle size of the olivine compound is preferably in a range of one-half or less, preferably, one-tenth or less of the average particle size of lithium nickelate. The lower limit of the average particle size of the olivine compound may be determined by various conditions of a process of producing the olivine compound. To certainly obtain the effect of the present invention, preferably, particles of the olivine compound is made finer. This is because the finer particles of the olivine compound are easier to densely cover surfaces of particles of lithium nickelate.

The coating thickness of the olivine compound on the surface of each of particles of lithium nickelate is preferably in a range of about 0.1 μm to about 10 μm. If the coating thickness is thinner than about 0.1 μm, it may fail to obtain the effect of the present invention. If the coating thickness is thicker than about 10 μm, the content of the olivine particles in a positive active material is too much, to reduce the charge/discharge capacity per volume and lower the energy density per volume, thereby failing to obtain a high charge/discharge capacity. Accordingly, the effect can be obtained by setting the coating thickness of the olivine compound on the surface of each of the particles of lithium nickelate within the above-described range according to an embodiment of the present invention.

In this way, the positive active material of the present invention is characterized by compensating the disadvantages of lithium nickelate and the olivine compound for each other, and combining the high charge/discharge capacity as the advantage of lithium nickelate with the high-temperature stability as the advantage of the olivine compound at a high level. Such a positive active material is superior to lithium cobaltate as the related art active material. The use of this positive active material provides a non-aqueous electrolyte secondary battery with a good charge/discharge capacity and good high-temperature stability.

A binder can be contained in the positive active material layer according to an embodiment of the present invention. The binder can include a known resin material having been generally used as a binder of a positive active material layer of a non-aqueous electrolyte secondary battery of this type. The positive active material layer may contain known additives, such as a conductive agent and/or other like constituents.

The positive can 3 adapted to contain the positive electrode 2 serves as an external terminal on the positive electrode side of the non-aqueous electrolyte secondary battery 1.

The negative electrode 4 is produced by forming a negative active material layer containing a negative active material on a negative current collector. The negative current collector is represented by a nickel foil.

The negative active material can include any material allowing lithium to be doped or undoped in or from the material. Examples of such materials include carbonaceous materials, for example, non-graphitizable carbon, artificial carbon, natural graphite, pyrolytic carbons, cokes such as pitch coke, needle coke, petroleum coke, graphites, vitreous carbons, a baked body of an organic polymer compound obtained by carbonizing phenol resin, furan resin, or the like at a suitable temperature, carbon fibers, and activated carbon. Further, metal lithium, a metal or semiconductor allowed to form an alloy or compound with lithium, and an alloy or compound thereof are usable as the negative active materials. Such a metal, alloy, or compound is expressed by a chemical formula DₛEₜLiᵤ, where D is at least one kind selected from metal elements each allowed to form an alloy or compound with lithium and E is at least one kind selected from metal elements and semiconductor elements other than lithium and D, and s, t, and u are specified so as to satisfy s>o, t≧o, and u≧o. In particular, the metal element or semiconductor element allowed to form an alloy or compound with lithium may be a group IV metal element or semiconductor element, preferably, silicon or tin, most preferably, tin. Oxides allowing lithium to be doped or undoped in or from the oxide at a relatively basic potential, such as iron oxide, ruthenium oxide, molybdenum oxide, tungsten oxide, titanium oxide, and tin oxide, and nitrides can be similarly usable as the negative active materials.

A binder to be contained in the negative active material layer according to an embodiment. The binder can include a known resin material having been generally used as a binder of a negative active material layer of a non-aqueous electrolyte secondary battery of this type.

The negative can 5 adapted to contain the negative electrode 4 serves as an external terminal on the negative electrode side of the non-aqueous electrolyte secondary battery 1.

Examples of the non-aqueous electrolytes include a non-aqueous electrolytic solution prepared by dissolving an electrolyte salt in a non-aqueous solvent, a solid electrolyte (inorganic electrolyte or polymer electrolyte containing an electrolyte salt), and a solid or gel-like electrolyte prepared by mixing or dissolving an electrolyte in a polymer compound or the like.

The non-aqueous electrolytic solution is prepared by dissolving an electrolyte in an organic solvent. The organic solvent can include any suitable type that has been generally used for batteries of this type. Examples of such organic solvents include propylene carbonate, ethylene carbonate, diethyl carbonate, dimethyl carbonate, 1,2-dimethoxyethane, 1,2-diethoxyethane, γ-butyrolactone, tetrahydrofuran, 2-methyl tetrahydrofuran, 1,3-dioxolane, 4-methyl-1,3-dioxolane, diethyl ether, sulfolane, methylsulfolane, acetonitrile, propionitrile, anisole, acetate, butyrate, propionate and the like. In particular, from the viewpoint of voltage stability, it is preferred to use cyclic carbonates such as propylene carbonate, or chain carbonates such as dimethyl carbonate and diethyl carbonate. These organic solvents can be used singly or in combination of two kinds or more.

The solid electrolyte can include an inorganic electrolyte, a polymer electrolyte and the like insofar as the material has lithium-ion conductivity. The inorganic electrolyte can include, for example, lithium nitride, lithium iodide and the like. The polymer electrolyte is composed of an electrolyte salt and a polymer compound in which the electrolyte salt is dissolved. Examples of the polymer compounds used for the polymer electrolyte include ether based polymers such as polyethylene oxide and cross-linked polyethylene oxide, polymethacrylate ester based polymers, acrylate based polymers and the like. These polymers may be used singly, or in the form of a mixture or a copolymer of two kinds or more.

A matrix of the gel electrolyte may be any polymer insofar as the polymer is gelated by absorbing the above-described non-aqueous electrolytic solution. Examples of the polymers used for the gel electrolyte include fluorocarbon polymers such as polyvinylidene fluoride, polyvinylidene-co-hexafluoropropylene and the like.

Examples of the polymers used for the gel electrolyte also include polyacrylonitrile and a copolymer of polyacrylonitrile. Examples of monomers (vinyl based monomers) used for copolymerization include vinyl acetate, methyl methacrylate, butyl methacylate, methyl acrylate, butyl acrylate, itaconic acid, hydrogenated methyl acrylate, hydrogenated ethyl acrylate, acrlyamide, vinyl chloride, vinylidene fluoride, and vinylidene chloride. Examples of the polymers used for the gel electrolyte further include acrylonitrile-butadiene copolymer rubber, acrylonitrile-butadiene-styrene copolymer resin, acrylonitrile-chlorinated polyethylene-propylene-diene-styrene copolymer resin, acrylonitrile-vinyl chloride copolymer resin, acrylonitrile-methacylate resin, and acrlylonitrile-acrylate copolymer resin.

Examples of the polymers used for the gel electrolyte include ether based polymers such as polyethylene oxide, copolymer of polyethylene oxide, and cross-linked polyethylene oxide. Examples of monomers used for copolymerization include polypropylene oxide, methyl methacrylate, butyl methacylate, methyl acrylate, butyl acrylate.

In particular, from the viewpoint of oxidation-reduction stability, a fluorocarbon polymer is preferably used for the matrix of the gel electrolyte.

The electrolyte salt used in the electrolyte may be any electrolyte salt having been generally used for batteries of this type. Examples of the electrolyte salts include LiClO₄, LiAsF₆, LiPF₆, LiBF₄, LiB(C₆H₅)₄, CH₃SO₃Li, CF₃SO₃Li, LiCl, LiBr and the like.

The separator 6 is adapted to separate the positive electrode 2 from the negative electrodes 4. The separator 6 can include any film-like material having been generally used for forming separators of non-aqueous electrolyte secondary batteries of this type, for example, a polymer film made from polypropylene. In addition, if a solid electrolyte or gel electrolyte is used as the electrolyte of the battery 1, the separator 6 is not necessarily provided.

The insulating gasket 7 is adapted to prevent leakage of a non-aqueous electrolytic solution filled in both the positive can 3 and the negative can 5, and is integrally assembled in the negative can 5.

In the coin-shaped non-aqueous electrolyte secondary battery 1 configured as described above, the positive active material is prepared by covering surfaces of particles of lithium nickelate with an olivine compound having an olivine type crystal structure, wherein lithium nickelate is expressed by the general formula Li_{y}Ni_{1-z}M′_{z}O₂ where 0.05≦y≦1.2 and 0≦z≦0.5, and M′ is one kind or more selected from a group consisting of Fe, Co, Mn, Cu, Zn, Al, Sn, B, Ga, Cr, V, Ti, Mg, Ca, and Sr, and the olivine compound is expressed by the general formula LiₓMPO₄ where 0.05≦x≦1.2, and M is one kind or more selected from a group consisting of Fe, Mn, Co, Ni, Cu, Zn, and Mg. Accordingly, it is possible to compensate the disadvantages of lithium nickelate and the olivine compound for each other, and combine the high charge/discharge capacity as the advantage of lithium nickelate with the high-temperature stability as the advantage of the olivine compound at a high level, and hence to enhance both the charge/discharge capacity and the high-temperature stability.

The non-aqueous electrolyte secondary battery 1 configured as described above is produced, if an electrolytic solution is used as the electrolyte, in accordance with the following manner pursuant to an embodiment of the present invention.

The positive electrode 2 is first produced as follows. A powder of lithium nickelate (LiNiO₂) and a powder of lithium-manganese based olivine compound (LiMnPO₄) as raw materials are slightly mixed at a specific ratio. In this case, the content of the olivine compound is set, for example, to 20 wt %.

As the olivine compound used for the present invention, there is preferably used an olivine compound synthesized at a baking temperature of about 500° C. to about 700° C. as disclosed in Japanese Patent Laid-open No. 2001-250555. It has been confirmed that an average particle size of the olivine compound synthesized at such a baking temperature is generally smaller than that of lithium nickelate, and more specifically, becomes as small as at least one-half or less of an average particle size of lithium nickelate. The particles of the olivine compound synthesized at the above-described baking temperature can be almost pulverized to particles having sizes being about one-tenth or less of particles of lithium nickelate. In other words, the particle sizes of the olivine compound can be reduced to particle sizes desirable as those of the material for covering surfaces of secondary particles of lithium nickelate.

On the contrary, in the case of using an olivine compound obtained by baking at a temperature of more than 700° C., since sizes of primary particles become too large, such an olivine compound is undesirable as the material for covering surfaces of particles of lithium nickelate.

Accordingly, the positive active material according to an embodiment the present invention can be certainly produced by using the olivine compound baked at the above-described temperature.

The mixture is then subjected to agitation accompanying strong friction and impact, to form a complex of lithium and the olivine compound, thereby covering surfaces of particles of lithium nickelate with the olivine compound.

The agitation accompanying strong friction and impact forces may be performed by using a disk mill which is one type of high speed rotary type impact crusher, a mixer/crusher, or a high speed agitator/mixer. With the use of such a crushing/agitating apparatus, the mixture to be put in the apparatus is subjected to a pulverization/agitation treatment accompanying sufficient and uniform strong friction and impact, whereby the surfaces of particles of the lithium nickelate are covered with the olivine compound by the strong friction and impact forces.

The treatment condition of the crushing/agitating apparatus may be suitably set depending on the specification of the apparatus, the amount of the mixture to be treated, and the like.

The positive electrode 2 is produced by using the mixture having been subjected to the pulverization and agitation treatment accompanying strong friction and impact as the positive active material. To be more specific, the positive active material mixed with a suitable amount of a conductive agent and a binder are dispersed in a solvent to prepare a positive mix in the form of slurry. The positive mix is uniformly applied on a positive current collector and is dried, to produce the positive electrode 2 having the positive active material layer.

The negative electrode 4 is then produced as follows. A negative active material and a binder are first dispersed in a solvent, to prepare a negative mix in the form of slurry. The negative mix is uniformly applied on a negative current collector and is dried, to produce the negative electrode 4 having the negative active material layer.

A non-aqueous electrolytic solution is prepared by dissolving an electrolyte salt in a non-aqueous solvent.

The positive electrode 2 is contained in the positive can 3 and the negative electrode 4 is contained in the negative can 5, and the separator 6 is disposed between the positive electrode 2 and the negative electrode 4. The positive can 3 and the negative can 5 are both filled with the non-aqueous electrolytic solution, and the positive can 3 and the negative can 5 are fixed to each other by caulking via the insulating gasket 7. The non-aqueous electrolyte secondary battery 1 is thus accomplished.

The shape of the non-aqueous electrolyte secondary battery is not particularly limited. For example, the secondary battery may be formed into not only the above-described coin-shape but also any shape such as a cylindrical shape, a square shape, a bottom shape, a laminated sheet shape and the like.

The method of producing each of the negative electrode and the positive electrode is not limited to that described above but may be any known method. For example, there can be adopted various known methods such as a method of adding known binder, conductive material, and the like to an active material, adding the mixture in a solvent, and applying the resultant slurry on a current collector, a method of adding known additive, and the like to an active material, heating the mixture, and applying the heated mixture to a current collector, and a method of molding an active material only into the shape of an electrode, or mixing a conductive material and a binder to an active material, and molding the mixture into the shape of an electrode.

More specifically, there can be adopted a method of mixing an active material with a binder and an organic solvent into slurry, applying the slurry on a current collector, and drying the slurry, and drying the slurry, and a method of molding an active material and a binder (if needed) under heat and pressure, to produce an electrode having a high strength.

The method of assembling the components into the battery is not particularly limited but may be any known method. For example, there can be adopted various known methods such as a lamination method of sequentially laminating the electrodes and the separator, and a winding method of preparing a sub-assembly of the electrodes and the separated interposed between the electrodes, and winding the sub-assembly around a winding core. In addition, the present invention can be effectively applied to a method of producing a square-shaped battery by the winding type.

### EXAMPLES

Examples of the present invention are described below without limitation to the present invention.

Each of these examples was carried out by producing a positive active material of the present invention and a non-aqueous electrolyte secondary battery using the positive active material, and evaluating the characteristics of the non-aqueous electrolyte secondary battery thus produced.

### Example 1

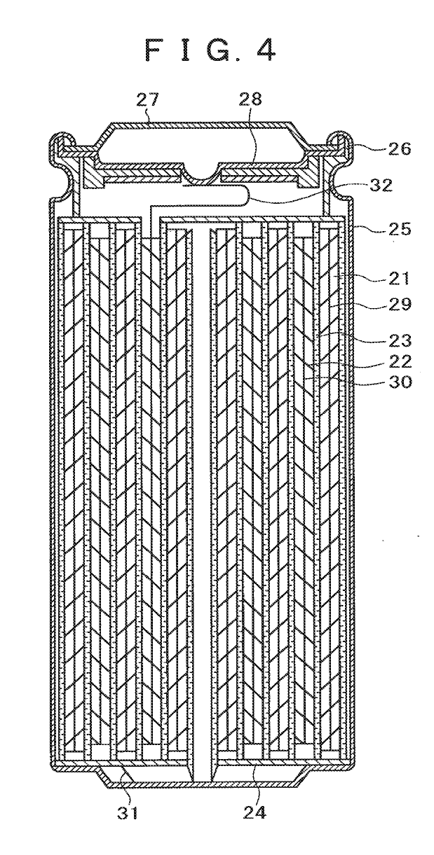

In this example, a positive active material and a cylindrical non-aqueous electrolyte secondary battery using the positive active material, having a configuration shown in FIG. 4, were produced as follows.

### (Production of Positive Electrode)

A positive active material was first produced. A powder of a lithium-manganese based olivine compound (LiMnPO₄) was added in an amount of 20 wt % to a powder of lithium nickelate (LiNiO₂). These powders were slightly mixed with each other. The mixture was put in a disk mill (one kind of high speed rotary impact crusher) and treated for 10 min. The crushing/agitating treatment was performed by rotating a circular plate having a disk at a rotational speed of 10,000 rpm.

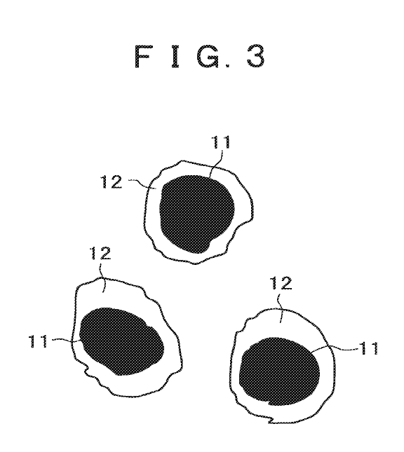

FIG. 2 is a schematic view showing the configuration of the disk mill. To sufficiently crush and agitate a material to be treated, the disk mill has a circulation structure adapted to feed the material to an outer peripheral portion once and then return the material to an agitating portion 9 by rotation of a disk 8. With the use of such a disk mill, the material can be sufficiently, uniformly crushed and agitated.

The mixture of lithium nickelate and the olivine compound put in the disk mill were crushed and agitated by means of a strong impact force given by the disk rotating at a high speed, as a result of which the surfaces of particles of lithium nickelate were covered with the olivine compound.

The cross-section of the material crushed (or pulverized) and agitated by the disk mill was observed by a scanning electron microscope (SEM) and an energy dispersive X-ray spectrometer (EDS). As a result, it was confirmed that small particles (hereinafter, referred to as “sub-particles”), from which phosphorus (P) was clearly detected, densely adhere in the form of a layer having a thickness of about 0.5 to about 3 μm around each of large particles (hereinafter, referred to as “base particles”), from which nickel (Ni) was clearly detected, having a diameter of about 10 to about 20 μm. This state is schematically shown in FIG. 3. In FIG. 3, a center black portion is a base particle 11, and a peripheral white portion surrounding the base particle 11 is a layer of the sub-particles 12. As a result of examination of kinds of the detected elements and sizes of the particles, it was confirmed that the base particle 11 is a particle of lithium nickelate and the sub-particle 12 is a particle of the olivine compound.

A battery was produced by using the material thus obtained as a positive active material.

A positive mix was prepared by mixing 90 wt % of the positive active material, 5 wt % of acetylene black as a conductive agent, and 5 wt % of polyvinylidene fluoride as a binder. The positive mix was dispersed in N-methyl-2-pyrrolidone as a solvent, to prepare slurry. The positive mix slurry was uniformly applied on both surfaces of a strip-like aluminum foil (thickness: 20 μm) as a positive current collector 30 and dried, followed by compression molding by a roll press, to obtain a strip-like positive electrode 22.

### (Production of Negative Electrode)

A negative electrode mix was prepared by mixing 90 parts by weight of graphite as a negative active material and 10 parts by weight of polyvinylidene fluoride (PVdF) as a binder. The negative mix was dispersed in N-methyl-2-pyrrolidone as a solvent, to prepare slurry. The negative mix slurry was uniformly applied on both surfaces of a strip-like copper foil (thickness: 10 μm) used as a negative current collector 29 and dried, followed by compression molding by a roll press, to obtain a strip-like negative electrode 21.

### (Battery Assembly)

The strip-like negative electrode 21, the strip-like positive electrode 22, and a separator 23 formed of a polyethylene film with pores (thickness: 25 μm) were laminated in this order, and the laminated body was spirally wound by a plurality of times, to produce a spiral type electrode element shown in FIG. 4.

The spiral type electrode element was contained in a nickel-plated iron made battery can 25, and insulating plates 24 were placed on upper and lower surfaces of the electrode element. An aluminum made positive lead 32 was led from the positive current collector 30, and was welded to a projecting portion of a safety valve 28 electrically connected to a battery lid 27. A nickel made negative lead 31 was led from the negative current collector 29 and was welded to the bottom of the battery can 25.

A non-aqueous electrolytic solution was prepared by dissolving 0.5 mol/L of LiN(CF₃SO₂)₂ and 0.5 mol/L of LiPF₆ as an electrolyte in a mixed solution of ethylene carbonate and dimethyl carbonate at a mixing ratio of 1:2.

The electrolytic solution was injected in the battery can 25 with the spiral electrode element assembled therein, and the battery can 25 was caulked via an asphalt coated insulating seal gasket 26, to fix the safety valve 28, a PTC device, and the battery lid 27. A cylindrical non-aqueous electrolyte secondary battery having an outer diameter of 18 mm and a height of 65 mm shown in FIG. 4 was thus produced.

### Comparative Example 1

A positive active material was prepared and a non-aqueous electrolyte secondary battery was produced in the same manner as that described in Example 1, except that a positive active material was prepared by mixing a powder of lithium nickelate (LiNiO₂) and a lithium-manganese based olivine compound (LiMnPO₄) for 30 min in a mortar.

### Comparative Example 2

A non-aqueous electrolyte secondary battery was produced in the same manner as that described in Example 1, except that lithium nickelate (LiNiO₂) was used as a positive active material.

The non-aqueous electrolyte secondary batteries in Example 1, Comparative Example 1, and Comparative Example 2 were evaluated in terms of high-temperature cycle characteristic. The high-temperature cycle characteristic was evaluated as follows.

### (Evaluation of High-Temperature Cycle Characteristic)

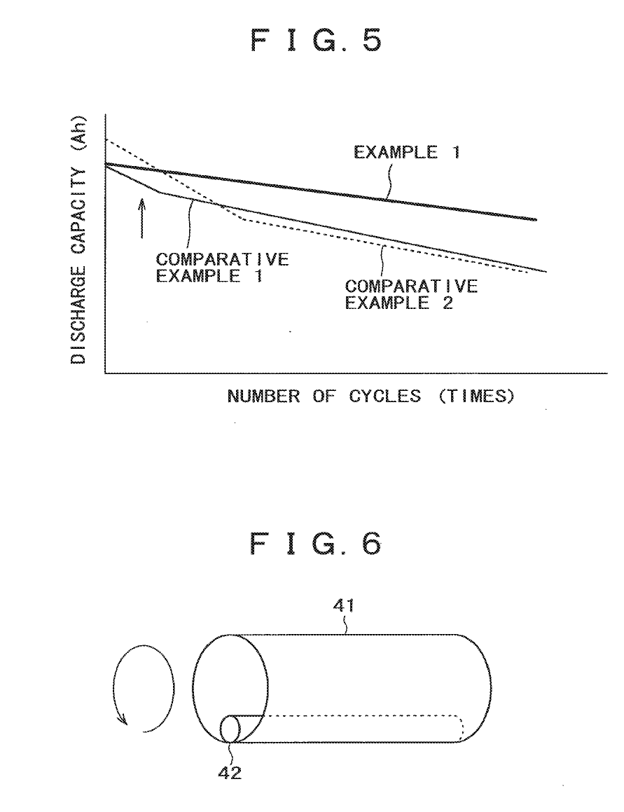

The battery in each of Example 1, Comparative Example 1, and Comparative Example 2 was charged under conditions with an environment temperature of 50° C., a charge voltage of 4.2 V, a charge current of 1,000 mA, and a charge time of 4 hr. After being subjected to such constant-current/constant-voltage charging, the battery was discharged at a discharge current of 1,000 mA and an end-point voltage 3.0 V. The charging/discharging was further repeated under the same conditions as those described above, to examine a change in discharge capacity. The results are shown in FIG. 5.

As is apparent from FIG. 5, with respect to the battery in Example 1, the discharge capacity is stably, gently reduced at a constant rate with an increase in cycle number, and even after repetition of charging/discharging by a large cycle number, a reduction in discharge capacity is small. This means that the battery in Example 1 has a characteristic capable of ensuring a high discharge capacity.

With respect to the battery in each of Comparative Example 1 and Comparative example 2, the discharge capacity is rapidly reduced in the initial state of cycling, and in the state after repetition of charging/discharging by a large cycle number, a reduction in discharge capacity is larger that of the battery in Example 1.

As a result, it becomes apparent that the present invention makes it possible to realize a positive active material superior to the related art positive active material in terms of discharge capacity and stability, and to realize a non-aqueous electrolyte secondary battery having a high discharge capacity, a high stability, and a stable high-temperature cycle characteristic by making use of the positive active material.

### Example 2

A powder of a lithium-manganese based olivine compound (LiMnPO₄) was added in an amount of 20 wt % to a powder of lithium nickelate (LiNiO₂). These powders were slightly mixed with each other. The mixture was put in an original mixer/crusher including a combination of a cylindrical vessel 41 and a crusher bar 42 shown in FIG. 6. The crusher is configured such that the cylindrical vessel 41 is rotated at a high speed along the circumferential path, to mix the raw materials with each other, wherein the crushed materials receive a strong friction force in a gap between the crushing bar 42 and the inner wall of the cylindrical vessel 41, whereby the peripheries of particles of lithium nickelate are covered with particles of the olivine compound. In this way, by using such a mixer/crusher, like Example 1, the surfaces of large particles of lithium nickelate can be covered with small particles of the olivine compound.

The cross-section of the material treated by the mixer/crusher was observed by a scanning electron microscope (SEM) and an energy dispersive X-ray spectrometer (EDS). As a result, it was confirmed that small particles (hereinafter, referred to as “sub-particles”), from which phosphorus (P) was clearly detected, densely adhere in the form of a layer having a thickness of about 0.5 to about 3 μm around each of large particles (hereinafter, referred to as “base particles”), from which nickel (Ni) was clearly detected, having a diameter of about 10 to about 20 μm. As a result of examination of kinds of the detected elements and sizes of the particles, it was confirmed that the base particle is a particle of lithium nickelate and the sub-particle is a particle of the olivine compound.

Using the positive active material thus produced, a non-aqueous electrolyte secondary battery was produced in the same manner as that described in Example 1, and the high-temperature cycle characteristic of the battery was evaluated in the same manner as that described above. As a result, it was confirmed that like Example 1, the discharge capacity is stably, gently reduced at a constant rate with an increase in cycle number, and even after repetition of charging/discharging by a large cycle number, a reduction in discharge capacity is small. This means that the battery in Example 2 has a characteristic capable of ensuring a high discharge capacity.

As a result, even in Example 2, it becomes apparent that the present invention makes it possible to realize a positive active material superior to the related art positive active material in terms of discharge capacity and stability, and to realize a non-aqueous electrolyte secondary battery having a high discharge capacity, a high stability, and a stable high-temperature cycle characteristic by making use of the positive active material.

### Example 3

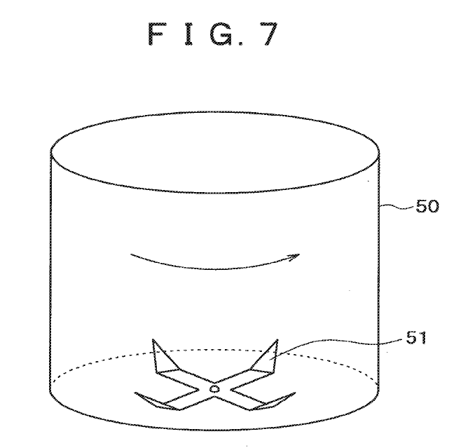

A powder of a lithium-manganese based olivine compound (LiMnPO₄) was added in an amount of 20 wt % to a powder of lithium nickelate (LiNiO₂). These powders were slightly mixed with each other. The mixture was put in a high-speed agitator/mixer shown in FIG. 7. The high-speed agitator/mixer is configured such that an agitating blade 51 in a vessel 50 is rotated at a blade tip speed of about 80 m/s, to make the raw materials in a high dispersion state while imparting a strong impact force to each of particles of the raw materials, whereby the peripheries of particles of lithium nickelate are covered with particles of the olivine compound. In this way, by using such a high-speed agitator/mixer, like Example 1, the surfaces of large particles of lithium nickelate can be covered with small particles of the olivine compound. In addition, the treatment time was set to 30 min.

The cross-section of the material treated by the high-speed agitator/mixer was observed by a scanning electron microscope (SEM) and an energy dispersive X-ray spectrometer (EDS). As a result, it was confirmed that small particles (hereinafter, referred to as “sub-particles”), from which phosphorus (P) was clearly detected, densely adhere in the form of a layer having a thickness of about 0.5 to about 3 μm around each of large particles (hereinafter, referred to as “base particles”), from which nickel (Ni) was clearly detected, having a diameter of about 10 to about 20 μm. As a result of examination of kinds of the detected elements and sizes of the particles, it was confirmed that the base particle is a particle of lithium nickelate and the sub-particle is a particle of the olivine compound.

Using the positive active material thus produced, a non-aqueous electrolyte secondary battery was produced in the same manner as that described in Example 1, and the high-temperature cycle characteristic of the battery was evaluated in the same manner as that described above. As a result, it was confirmed that like Example 1, the discharge capacity is stably, gently reduced at a constant rate with an increase in cycle number, and even after repetition of charging/discharging by a large cycle number, a reduction in discharge capacity is small. This means that the battery in Example 3 has a characteristic capable of ensuring a high discharge capacity.

As a result, even in Example 3, it becomes apparent that the present invention makes it possible to realize a positive active material superior to the related art positive active material in terms of discharge capacity and stability, and to realize a non-aqueous electrolyte secondary battery having a high discharge capacity, a high stability, and a stable high-temperature cycle characteristic by making use of the positive active material.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A positive active material comprising:
one or more particles of lithium nickelate having a surface and having a formula Li_{y}Ni_{1-z}M′_{z}O₂ where 0.05≦y≦1.2 and 0≦z≦0.5, and M′ is selected from the group consisting of Fe, Co, Mn, Cu, Zn, Al, Sn, B, Ga, Cr, V, Ti, Mg, Ca, Sr and mixtures thereof; and
an olivine compound having an olivine-type crystal structure and having a formula LiₓMPO₄ where 0.05≦x≦1.2, and M is selected from a group consisting of Fe, Mn, Co, Ni, Cu, Zn, Mg and mixtures thereof;
wherein the surface of the particles of lithium nickelate are covered with the olivine compound; and
wherein a content of the olivine compound in the positive active material ranges from about 5 wt % to about 50 wt %.

2. The positive active material according to claim 1, wherein the olivine compound is in a form of particles, and wherein an average particle size of the particles of the olivine compound is one-half or less as compared to an average particle size of the particles of lithium nickelate.

3. The positive active material according to claim 1, wherein a coating thickness of the olivine compound ranges from about 0.1 μm to about 10 μm.

4. A non-aqueous electrolyte secondary battery comprising:
a positive electrode including a positive active material;
a negative electrode; and
a non-aqueous electrolyte;
wherein the positive active material includes one or more particles of lithium nickelate having a surface and having a formula Li_{y}Ni_{1-z}M′_{z}O₂ where 0.05≦y≦1.2 and 0≦z≦0.5, and M′ is selected from the group consisting of Fe, Co, Mn, Cu, Zn, Al, Sn, B, Ga, Cr, V, Ti, Mg, Ca, Sr and mixtures thereof; and
an olivine compound having an olivine type crystal structure and having a formula LiₓMPO₄ where 0.05≦x≦1.2, and M is selected from the group consisting of Fe, Mn, Co, Ni, Cu, Zn, Mg and mixtures thereof;
wherein the surface of the particles of lithium nickelate are covered with the olivine compound; and
wherein a content of the olivine compound in the positive active material ranges from about 5 wt % to about 50 wt %.

5. The non-secondary electrolyte secondary battery according to claim 4, wherein the negative electrode includes a material selected from a group consisting of metal lithium, a lithium alloy, and a material allowing lithium to be doped or undoped in or from the material.

6. The non-secondary electrolyte secondary battery according to claim 4, wherein the olivine compound is in a form of particles, and wherein an average particle size of the particles of the olivine compound is one-half or less as compared to an average particle size of the particles of lithium nickelate.

7. The non-secondary electrolyte secondary battery according to claim 4, wherein a coating thickness of the olivine compound ranges from about 0.1 μm to about 10 μm.
